(19) United States
(12) Patent Application Publication
(10) Pub. No.: US 2017/0114424 A1
(43) Pub. Date: Apr. 27, 2017

(54) Process for Preparing a Flame-retardant, Lightfast, Low Fogging and Degradable Car Seat Leather

(71) Applicant: Yantai University, Yantai (CN)

(72) Inventors: Baorong DUAN, Yantai (CN); Quanjie WANG, Yantai (CN); Zhihai TANG, Yantai (CN); Haiyan DING, Yantai (CN); Mengmeng ZHANG, Yantai (CN); Lijie HOU, Yantai (CN); Yanqing WANG, Yantai (CN); Guilin LIU, Yantai (CN)

(73) Assignee: Yantai University

(21) Appl. No.: 15/334,763

(22) Filed: Oct. 26, 2016

(30) Foreign Application Priority Data
Oct. 26, 2015 (CN) 201510694401.6

(51) Int. Cl. C14C 3/10; C14C 9/02; C14C 11/00; C14C 3/28; C14C 1/08

(52) U.S. Cl. CPC C14C 3/10; C14C 3/28; C14C 1/08; C14C 11/006; C14C 9/02

(57) ABSTRACT

The present invention discloses a process for preparing a flame-retardant, lightfast, low fogging and degradable car seat leather wherein ammonia salt deliming is replaced with an ammonia free one, tetrakis hydroxymethyl phosphonium sulfate and the flame-retardant starchy leather surfactant are used as the tanning agents to replace the conventional chrome tanning agent, hot water washing is used to reduce the fogging value of the seat leather, the flame-retardant performance is enhanced by combination of retanning, greasing and coating, the lightfast material is applied to enhance the lightfastness of the coating and the spray coating is replace with the roller coating to lower the consumption of the paints.

### FIELD OF INVENTION

The present invention relates to a process for preparing a car seat leather, particularly relates to a process for preparing a flame-retardant, lightfast, low fogging and degradable car seat leather.

### BACKGROUND OF INVENTION

In view of the history of the automobile industry development in the world, the car production and sales are increasing exponentially with the improvement of living standards of human beings. One in every two people in a developed country has a car. Since China joined WTO in 2001, the car production and sales in the market have soared. Although the car production was 81,000 only in 1991, the number soared up to 1.092 millions by 2002 and the car sales exceeded 23 millions in 2014. With more cars manufactured, its supporting business on interior decorations is bound to grow rapidly and more and more superior quality products have been developed. In terms of the car manufacturing, the degree of leather usage has always been a symbol of luxury. As an application of leather in automobile industry, a leathered seat has been known to us for a long time and the products of superior quality and safety are being developed. As leather is being used to decorate the roof and sides in a car, the decoration leather is imperative in pursuit of high-end luxury models. As such, the automotive leather has a broad market prospect.

A process of the prior art for preparing the car seat leather is notorious for its serious chrome and ammonia pollutions and its finished leather has drawbacks of higher fogging value, poor flame retardancy and lightfastness, and unsatisfied degradation.

### SUMMARY OF INVENTION

It is an object of the present invention to provide a process for preparing the car seat leather that has a better flame-retardancy and lightfastness, lower fogging value, and higher degradation.

In accordance with one aspect of the present invention:

a process for preparing a flame-retardant, lightfast, low fogging and degradable car seat leather, wherein the deliming step: the deliming agent is selected from any one of the group consisting of magnesium citrate, magnesium chloride, 2-hydroxy-1,2,3 propane tricarboxylic acid magnesium, ethylmagnesium chloride, magnesium methacrylate, magnesium lactate, 4-methyl salicylate, potassium acetate and potassium gluconate; in the tanning step: 4% tetrakis hydroxymethyl phosphonium sulfate, 0.2% lactic acid, 0.2% 4-methyl salicylate, 4% flame retardant starchy leather surfactant and 5% bayberry tannin extract are added to the pickling bath at temperature of 35° C. under operation for 4 h,

and the common denominator for the amount percentage of the above materials is the mass of the split rawhides after fleshing;

in the rewet step: 0.6% flame-retardant starchy leather surfactant and 0.5% formic acid are added to a 100% bath at temperature of 35° C. under operation for 40 min;

in the retanning step: 2% retanning intumescent flame retardant and 1% intumescent starchy flame retardant for leather purpose are added to a 100% bath at temperature of 40° C. under operation for 2 h, then water washing, and netrualizing followed by draining and water washing;

in the greasing step: 6% synthetic fatliquor, 0.2% sodium diacetate, 1% flame-retardant phosphorylated fatliquor A and 3% flame-retardant phosphorylated fatliquor B are added to a 100% bath at temperature of 35° C. under operation for 40 min, then 100% water is added, the bath temperature is raised to 50° C. followed by adding aluminum tanning agent under operation for 60 min, then 0.5% phthalic anhydride and 1.5% formic acid are sequentially added under operation for 45 min, followed by draining and water washing, and the common denominator for the percentage of the above materials and the added water is the mass of the evenly-shaved hides;

the temperature of washing water after retanning is 50 , the temperature of washing water after neutralizing is 55° C. and the temperature of washing water after greasing is 65° C.;

in the coating step: i) the weight ratio of the coating ingredients for the primer:aqueous pigment paste:water:lightfast paint:the lightfast paint of CNT-modified acrylic-based resin: lightfast aqueous polyurethane:flame-retardant paint=2:25:6:5:5:6, ii) the weight ratio of the coating ingredients for the intermediate coating:water:matting polyurethane:glossy polyurethane:crosslinking agent=20:40:15:10, iii) the weight ratio of the coating ingredients for the top coating:water:feeling agent=14:6, and a roller is used at temperature of 102° C. by coating thrice for the primer, twice for the intermediate and once for the top.

The technical advancements offered by the present invention include the realization of:

1. In accordance with the present invention, ammonium salts are replaced with ammonium-free salts for deliming, and magnesium citrate, magnesium chloride, 2-hydroxy-1,2,3 propane tricarboxylic acid magnesium, ethylmagnesium chloride, magnesium methacrylate, magnesium lactate, 4-methyl salicylate, potassium acetate and potassium gluconate are used as ammonium-free deliming agents, reducing the content of ammonia and nitrogen in the waste water and the compounds of small molecules in the seat leather that in turn facilitates to lower the fogging value of the seat leather. 4-methyl salicylic acid and lactic acid can facilitate the penetration and dispersion of tetrakis hydroxymethyl phosphonium sulfate in the leather.

2. In accordance with the present invention, tetrakis hydroxymethyl phosphonium sulfate and the flame-retardant starchy leather surfactant are used as leather tanning agents to replace conventional chrome tanning agents, leading to a solution to the problem of chromium pollution in a process of the prior art for preparing the car seat leather. Moreover, the flame-retardant starchy leather surfactant not only can facilitate the penetration of tetrakis hydroxymethyl phosphonium sulfate but also can be used as a flame-retardant tanning agent in the tanning step.

3. In accordance with the present invention, the fogging value of seat leather is reduced effectively by gradually increasing the temperature of washing water in the steps of neutralizing and greasing and thoroughly washing out the compounds of small molecules.

4. In accordance with the present invention, appropriate technical measures are taken in each step such as tanning, rewet, retanning, greasing and coating to enhance the flame retardant performance of the leather. For example, sodium diacetate is used in the greasing step to facilitate the penetration of the flame-retardant phosphorylated fatliquor, and as the aluminum tanning agent can favorably stabilize the flame retardant phosphorylated fatliquor, the absorption of the flame retardant into the leather is further enhanced. Phthalic anhydride can also stabilize the flame-retardant phosphorylated fatliquor satisfactorily.

5. In accordance with the present invention, lightfastness of the coating is enhanced by using lightfast materials, and the consumption of paints is reduced by replacing spray coating with roller coating.

### DETAILED DESCRIPTIONS OF THE PREFERRED EMBODIMENTS

The present invention is now further described with reference to the following examples.

In one exemplary embodiment in accordance with the present invention, the process for preparing a flame-retardant, lightfast, low fogging and degradable car seat leather includes sequentially implementing the steps of: flaying, soaking, fleshing, liming, splitting, deliming, softening, pickling, tanning, aging, shaving, rewet, retanning, water washing, neutralizing, draining and water washing, greasing, draining and water washing, dyeing and static conditioning, water squeezing and stretching, wet oscillating, vacuum drying, oscillating, softening by swing, and coating,

wherein the deliming step: 1% deliming agent is added to 200% bath at temperature of 19-20° C. under operation for 120min and the bath pH is measured to be 9, comparing 9 deliming methods that use 9 deliming agents, i.e., magnesium citrate, magnesium chloride, 2-hydroxy-1,2,3 propane tricarboxylic acid magnesium, ethylmagnesium chloride, magnesium methacrylate, magnesium lactate, 4-methyl salicylate, potassium acetate and potassium gluconate, they all use the same amount of deliming agent and all the deliming agents are added at the same timing, and after deliming, the bare hide is tested for its feeling and looking and the bath is tested to get its pH, and there is no significant difference between the 9 deliming methods and all can meet the deliming requirement as expected;

wherein the tanning step: 4% tetrakis hydroxymethyl phosphonium sulfate, 0.2% lactic acid, 0.2% 4-methyl salicylate, 4% flame-retardant starchy leather surfactant and 5% bayberry tannin extract are added to the pickling bath at temperature of 35° C. and pH=4.2 under operation for 4h, and the common denominator for the amount percentage of the above materials is the mass of the split rawhides after fleshing;

wherein the rewet step: 0.6% flame-retardant starchy leather surfactant and 0.5% formic acid are added to a 100% bath at temperature of 35° C. under operation for 40 min; wherein the retanning step: 2% retanning intumescent flame retardant and intumescent starchy flame retardant are added to a 100% bath at temperature of 40° C. and pH=5 under operation for 2 h, then draining and water washing, and conventionally neutralizing followed by draining and waterwashing;

wherein the greasing step: 6% synthetic fatliquor SE, 0.2% sodium diacetate, 1% flame-retardant phosphorylated fatliquor A and 3% flame-retardant phosphorylated fatliquor B are added to a 100% bath at temperature of 35° C. under operation for 40 min, then 100% water is added, the bath temperature is raised to 50° C. followed by adding aluminum tanning agent under operation for 60 min, then 1.5% formic acid is added under operation for 45 min, followed by draining and water washing,

the temperature of washing water after retanning is 50° C., the temperature of washing water after neutralizing is 55° C. and the temperature of washing water after greasing is 65° C.,

the common denominator for the percentage of the above materials and the added water is the mass of the evenly-shaved hides;

wherein the retanning intumescent flame retardant is prepared in accordance with example 3 in Chinese patent CN2010100136107 titled A Method for Preparing a Retanning Intumescent Flame Retardant, intumescent starchy flame retardant for leather purpose is prepared in accordance with example 3 in Chinese patent CN201010534448.3 titled A Method for Preparing an Intumescent Starchy Flame Retardant, the flame-retardant starchy leather surfactant is prepared in accordance with example 2 in Chinese patent CN2010105344500 titled A Method for Preparing a Flame-retardant Starchy Leather Surfactant, intumescent starchy flame retardant for leather purpose is prepared in accordance with example 3 in Chinese patent CN201010534448.3 titled A Method for Preparing an Intumescent Starchy Flame Retardant, the flame-retardant phosphorylated fatliquor A is prepared in accordance with example 2 in Chinese patent CN2014104301474 titled A Method for Preparing a Flame-retardant Phosphorylated Fatliquor A and the flame-retardant phosphorylated fatliquor B is prepared in accordance with example 1 in Chinese patent CN2012104160636 titled A Method for Preparing a Flame-retardant Phosphorylated Fatliquor B;

wherein the coating step: i) the weight ratio of the coating ingredients for the primer: aqueous pigment paste NEOSAN 2000:water:lightfast paint:the lightfast paint of CNT-modified acrylic-based resin:lightfast aqueous polyurethane:flame-retardant paint=2:25:6: 5:5:6, ii) the weight ratio of the coating ingredients for the intermediate coating:water: matting polyurethane MATT 200:glossy polyurethane HPV-C:crosslinking agent PERIFIN AX-892=20:40:15:10, iii) the weight ratio of the coating ingredients for the top coating:water:feeling agent 2229W=14:6, a roller is used for coating at temperature of 102° C. thrice for the primer, twice for the intermediate and once for the top; wherein the lightfast paint is prepared in accordance with example 2 in Chinese patent

CN2012101051533 titled A Method for Preparing a Lightfast Paint, the the lightfast paint of CNT-modified acrylic-based resin is prepared in accordance with example 3 in Chinese patent CN2013101272066 titled A Method for Preparing a Nanotube Modified Acrylic-based Resin Lightfast Paint, the lightfast aqueous polyurethane is prepared in accordance with example 2 in Chinese patent CN2013100343312 titled A Method for Preparing a Lightfast Aqueous Polyurethane and the flame-retardant paint is prepared in accordance with example 2 in Chinese patent CN2013100942713 titled A Method for Preparing a Flame-retardant Paint.

Some manufacturers of the raw materials used in the embodiments in accordance with the present invention are shown in Table 1.

TABLE 1

| No | Raw material | Manufacturer |
|---|---|---|
| 1 | synthetic fatliquor SE | Shanghai Leather Chemical Plant |
| 2 | aqueous pigment paste | Klein Chemical Group |
| | NEOSAN 2000 | |
| 3 | matting polyurethane MATT | Wenzhou Shibang Polymer Materials |
| | 200 | Co., Ltd |
| 4 | glossy polyurethane HPV-C | CYTEG |
| 5 | cross-linking agent PERIFIN | Parke-Davis |
| | AX-892 | |
| 6 | feeling agent 2229W | Shandong Kawasawa Trading |
| | | Company |
| 7 | Bactericides 72 | Hui Ying Leather Industrial Co., Ltd. |
| 8 | soaking agent Humectan RDL | Hui Ying Leather Industrial Co., Ltd. |
| 9 | Auxiliary liming | Hui Ying Leather Industrial Co., Ltd. |
| | agent DERMOLLAN AR | |
| 10 | HLS high absorption chrome | Brothers Chemical Co., Ltd. |
| | tanning powder | |
| 11 | degreasing agent FA | Klein Chemical Group |
| 12 | bayberry tannin extract | Hubei Jusheng Technology Co., Ltd. |
| 13 | aluminum tanning agent | Zhanjiang Civita Chemical Co., Ltd. |

The common raw materials used in accordance with the present invention such as formic acid, sodium carbonate, sodium, magnesium lactate, 4-methyl salicylate, potassium acetate, potassium gluconate can be purchased from a proper manufacturer. Except for those specified above, all raw materials can be ordered from Hui Ying Industrial Co., Ltd. as required. The technical specifications for the leather prepared in accordance with the present invention v. a typically degradable leather of the prior art are shown in Table 2.

TABLE 2

| | | Leather of | |
|---|---|---|---|
| | | present | Leather of |
| Item | Test standard | invention | the prior art |
| Moist heat shrinkage | QB/T 2713-2005 | 81 | 82 |
| temperature/° C. | | | |
| Dry heat shrinkage | Q/0600QJS002-2013 | 135 | 130 |
| temperature/° C. | | | |
| Tensile | QB/T2710-2005 | 15.1 | 14.6 |
| strength/MPa | | | |
| Lightfastness/grade | QB/T2727-2005 | 4-5 | 3-4 |
| Fogging value/mg | DIN75201-2011 | 1.5 | 4.3 |
| Oxygen index/% | GB/T5455-1997 | 32 | 30 |
| Continued burning | GB/T5455-1997 | 5 | 10 |
| time/s | | | |
| Smoldering time/s | GB/T5455-1997 | 5 | 15 |
| Leather degradation/ | Q/0600QJS001-2013 | 72 | 54 |
| % | | | |

It can be seen from Table 2 that the leather prepared by the method in accordance with the present invention is superior to a leather of the prior art in terms of lightfastness, fogging value, oxygen index and degradation.

1. A process for preparing a flame-retardant, lightfast, low fogging and degradable car seat leather, wherein the deliming step: the deliming agent is selected from any one of the group consisting of magnesium citrate, magnesium chloride, 2-hydroxy-1,2,3 propane tricarboxylic acid magnesium, ethylmagnesium chloride, magnesium methacrylate, magnesium lactate, 4-methyl salicylate, potassium acetate and potassium gluconate; in the tanning step: 4% tetrakis hydroxymethyl phosphonium sulfate, 0.2% lactic acid, 0.2% 4-methyl salicylate, 4% flame retardant starch-type leather surfactant and 5% bayberry tannin extract are added to a pickling bath at temperature of 35° C. under operation for 4 h,
and the common denominator for the amount percentage of the above materials is the mass of the split rawhides after fleshing.

2. The process for preparing a flame-retardant, lightfast, low fogging and degradable car seat leather as claimed in claim 1, wherein the rewet step: 0.6% flame-retardant starchy leather surfactant and 0.5% formic acid are added to a 100% bath at temperature of 35° C. under operation for 40 min;
in the retanning step: 2% retanning intumescent flame retardant and 1% intumescent starchy flame retardant for leather purpose are added to a 100% bath at temperature of 40° C. under operation for 2h, then water washing, and netrualizing followed by draining and water washing;
in the greasing step: 6% synthetic fatliquor, 0.2% sodium diacetate, 1% flame-retardant phosphorylated fatliquor A and 3% flame-retardant phosphorylated fatliquor B are added to a 100% bath at temperature of 35° C. under operation for 40 min, then 100% water is added, the bath temperature is raised to 50° C. followed by adding aluminum tanning agent under operation for 60 min, then 0.5% phthalic anhydride and 1.5% formic acid are sequentially added under operation for 45min, followed by draining and water washing,
and the common denominator for the percentage of the above materials and the added water is the mass of the evenly-shaved hides.

3. The process for preparing a flame-retardant, lightfast, low fogging and degradable car seat leather as claimed in claim 2, wherein the temperature of washing water after retanning is 50° C., the temperature of washing water after neutralizing is 55° C. and the temperature of washing water after greasing is 65° C.

4. The process for preparing a flame-retardant, lightfast, low fogging and degradable car seat leather as claimed in claim 1, wherein the coating step: i) the weight ratio of the coating ingredients for the primer:aqueous pigment paste:water:lightfast paint:the lightfast paint of CNT-modified acrylic-based resin:aqueous polyurethane:flame-retardant paint=2:25:6:5:5:6, ii) the weight ratio of the coating ingredients for the intermediate coating:water:matting polyurethane:glossy polyurethane:crosslinking agent=20:40:15:10, iii) the weight ratio of the coating ingredients for the top coating:water:feeling agent=14:6, and a roller is used for coating at temperature of 102° C. thrice for the primer, twice for the intermediate and once for the top.

5. The process for preparing a flame-retardant, lightfast, low fogging and degradable car seat leather as claimed in claim 2, wherein the coating step: i) the weight ratio of the coating ingredients for the primer:aqueous pigment paste:water:lightfast paint:the lightfast paint of CNT-modified acrylic-based resin:aqueous polyurethane:flame-retardant paint=2:25:6:5:5:6, ii) the weight ratio of the coating ingredients for the intermediate coating:water:matting polyurethane:glossy polyurethane:crosslinking agent=20:40:15:10, iii) the weight ratio of the coating ingredients for the top coating:water:feeling agent=14:6, and a roller is used for coating at temperature of 102° C. thrice for the primer, twice for the intermediate and once for the top.

6. The process for preparing a flame-retardant, lightfast, low fogging and degradable car seat leather as claimed in claim 3, wherein the coating step: i) the weight ratio of the coating ingredients for the primer:aqueous pigment paste:water:lightfast paint:the lightfast paint of CNT-modified acrylic-based resin:aqueous polyurethane:flame-retardant paint=2:25:6:5:5:6, ii) the weight ratio of the coating ingredients for the intermediate coating:water:matting polyurethane:glossy polyurethane:crosslinking agent=20:40:15:10, iii) the weight ratio of the coating ingredients for the top coating:water:feeling agent=14:6, and a roller is used for coating at temperature of 102° C. thrice for the primer, twice for the intermediate and once for the top.
